(19) United States
(12) Patent Application Publication
(10) Pub. No.: US 2019/0077353 A1
(43) Pub. Date: Mar. 14, 2019

(54) COGNITIVE-BASED VEHICULAR INCIDENT ASSISTANCE

(71) Applicant: INTERNATIONAL BUSINESS MACHINES CORPORATION, Armonk, NY (US)

(72) Inventors: RODOLFO LOPEZ, Austin, TX (US); LOUIE A. DICKENS, TUCSON, AZ (US); JULIO A. MALDONADO, Austin, TX (US)

(21) Appl. No.: 15/703,858

(22) Filed: Sep. 13, 2017

(51) Int. Cl. B60R 21/0132; G08G 1/00; G07C 5/00; B60W 50/00; G06F 11/07

(52) U.S. Cl. CPC B60R 21/0132; G08G 1/205; G06F 11/079; B60W 50/00; G07C 5/008

(57) ABSTRACT

An apparatus, method, program product, and system are disclosed for cognitive-based vehicular incident assistance. A sensor module samples, on a continuous basis at periodic intervals, motion data from one or more sensors of a vehicle while the vehicle is in motion. An incident module detects that the vehicle is involved in a traffic incident based on the one or more sensors. An aggregation module scrapes, at the time of the traffic incident, external data sources available over one or more data networks for data related to the traffic incident, and supplements the sampled motion data with the scraped data related. A recommendation module generates and makes available, in real-time, one or more recommendations for responding to the traffic incident using cognitive computing processes based on the supplemented motion data. The one or more recommendations include information specific to a role of one or more individuals at the traffic incident.

### FIELD

The subject matter disclosed herein relates to cognitive computing and more particularly relates to assessing a traffic incident scene using cognitive-computing generated recommendations.

### BACKGROUND

Vehicles may include sensors that capture data about the vehicle and its surroundings. When vehicles are involved in traffic incidents, it can be difficult to determine who is at fault, whether the driver was actually breaking the law, and/or the like. Sensor data captured by a vehicle's sensors is rarely, if ever, used to help process traffic incidents.

### SUMMARY

An apparatus, method, and system for cognitive-based vehicular incident assistance is disclosed. One embodiment of an apparatus includes a sensor module that samples, on a continuous basis at periodic intervals, motion data from one or more sensors of a vehicle while the vehicle is in motion. The apparatus includes an incident module that detects that the vehicle is involved in a traffic incident based on the one or more sensors. The apparatus includes an aggregation module that scrapes, at the time of the traffic incident, external data sources available over one or more data networks for data related to the traffic incident, and supplements the sampled motion data with the scraped data related. The apparatus includes a recommendation module that generates and makes available, in real-time, one or more recommendations for responding to the traffic incident using cognitive computing processes based on the supplemented motion data. The one or more recommendations include information specific to a role of one or more individuals at the traffic incident.

One embodiment of a system for cognitive-based vehicular incident assistance includes a vehicle that includes one or more computing devices, and one or more sensors communicatively coupled to the one or more computing devices. The system includes a remote server communicatively coupled to the one or more computing devices over one or more computer networks. The remote server executes one or more cognitive computing processes. The system includes a sensor module that samples, on a continuous basis at periodic intervals, motion data from one or more sensors of a vehicle while the vehicle is in motion. The system includes an incident module that detects that the vehicle is involved in a traffic incident based on the one or more sensors. The system includes an aggregation module that scrapes, at the time of the traffic incident, external data sources available over one or more data networks for data related to the traffic incident, and supplements the sampled motion data with the scraped data related. The system includes a recommendation module that generates and makes available, in real-time, one or more recommendations for responding to the traffic incident using cognitive computing processes based on the supplemented motion data. The one or more recommendations include information specific to a role of one or more individuals at the traffic incident.

One embodiment of a method for cognitive-based vehicular incident assistance includes sampling, on a continuous basis at periodic intervals, motion data from one or more sensors of a vehicle while the vehicle is in motion. The method includes detecting that the vehicle is involved in a traffic incident based on the one or more sensors of the vehicle. The method includes scraping, at the time of the traffic incident, external data sources available over one or more data networks for data related to the traffic incident. The method includes supplementing the sampled motion data with the scraped data related to the traffic incident. The method includes generating and making available, in real-time, one or more recommendations for responding to the traffic incident using cognitive computing processes based on the supplemented motion data. The one or more recommendations include information specific to a role of one or more individuals at the traffic incident.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and shall not be considered to be limiting of scope, the embodiments will be described and explained with additional specificity and detail through the use of the accompanying drawings, in which:

FIG. 1 is a schematic block diagram illustrating one embodiment of a system for cognitive-based vehicular incident assistance;

FIG. 2 is a schematic block diagram illustrating one embodiment of an apparatus for cognitive-based vehicular incident assistance;

FIG. 3 is a schematic block diagram illustrating one embodiment of another apparatus for cognitive-based vehicular incident assistance;

FIG. 4 is a schematic flow chart diagram illustrating one embodiment of a method for cognitive-based vehicular incident assistance;

FIG. 5A is a schematic flow chart diagram illustrating one embodiment of a portion of a method for cognitive-based vehicular incident assistance; and

FIG. 5B is a schematic flow chart diagram illustrating one embodiment of a portion of the method of FIG. 5A for cognitive-based vehicular incident assistance.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software as executable code for execution by various types of processors. An identified module of executable code may, for instance, comprise one or more physical or logical blocks of computer instructions which may, for instance, be organized as an object, procedure, or function. Nevertheless, the executable code of an identified module need not be physically located together, but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

The description of elements in each figure may refer to elements of proceeding figures. Like numbers refer to like elements in all figures, including alternate embodiments of like elements.

An apparatus, method, and system for cognitive-based vehicular incident assistance is disclosed. One embodiment of an apparatus includes a sensor module that samples, on a continuous basis at periodic intervals, motion data from one or more sensors of a vehicle while the vehicle is in motion. The apparatus includes an incident module that detects that the vehicle is involved in a traffic incident based on the one or more sensors. The apparatus includes an aggregation module that scrapes, at the time of the traffic incident, external data sources available over one or more data networks for data related to the traffic incident, and supplements the sampled motion data with the scraped data related. The apparatus includes a recommendation module that generates and makes available, in real-time, one or more recommendations for responding to the traffic incident using cognitive computing processes based on the supplemented motion data. The one or more recommendations include information specific to a role of one or more individuals at the traffic incident.

In one embodiment, the cognitive computing processes are performed on a remote server accessible via the Internet from one or more devices at the traffic incident. In some embodiments, the remote server is communicatively coupled to the one or more external data sources to supplement the motion data received at the remote server. In further embodiments, the cognitive computing processes perform one or more machine learning and artificial intelligence functions on the supplemented motion data to determine the one or more recommendations.

In one embodiment, the cognitive computing processes calculate a risk value associated with each of the one or more recommendations based on the supplemented motion data. The risk value may be presented with the one or more recommendations. In various embodiments, the cognitive computing processes further access and analyze traffic incident data from previous traffic incidents for traffic incident data that is similar to one or more conditions of the traffic incident to generate the one or more recommendations for responding to the traffic incident.

In one embodiment, the apparatus includes an individual module that determines whether an individual in the vehicle is conscious and injured. The one or more recommendations may be generated with information for the individual and presented to the individual in response to determining that the individual is conscious. The individual information may include recommendations for treating an injury, recommendations for cooperating with law enforcement officers, and/or recommendations for interacting with emergency responders.

In certain embodiments, the individual module presents one or more audible prompts through the vehicle to the individual to determine whether the individual is conscious and injured based on the individual's responses to the audible prompts. In one embodiment, the apparatus includes an emergency responder module that generates the one or more recommendations with emergency response information related to the traffic incident and presented to one or more emergency responders on scene at the traffic incident in response to determining that an individual in the vehicle is one of unconscious and injured. The emergency response information may include treatment recommendations for the individual.

In one embodiment, the apparatus includes a law enforcement module that generates the one or more recommendations with law enforcement information related to the traffic incident and presented to one or more law enforcement officers on scene at the traffic incident. The law enforcement information includes one or more of fault information and citation recommendations. In some embodiments, the sensor module samples sensor data from one or more sensors that are external to the vehicle. The one or more sensors may be associated with vehicles that are within a proximity of the traffic incident, traffic signal control systems, and/or location services.

In one embodiment, the sensor module stores motion data in a first-in-last-out manner such that when a new set of motion data is sampled, the oldest set of sampled motion data is removed from storage. In further embodiments, the sensor module immediately samples a set of motion data in response to the incident module detecting that the vehicle is involved in a traffic incident.

In one embodiment, the apparatus includes a lockdown module that prevents access to one or more vehicle settings during the traffic incident and formats the sampled motion data in a read-only format. In various embodiments, the one or more sensors of the vehicle are selected from the group consisting of a speedometer, an accelerometer, a camera, a video camera, a sound sensor, a proximity sensor, a motion sensor, and a location sensor.

One embodiment of a system for cognitive-based vehicular incident assistance includes a vehicle that includes one or more computing devices, and one or more sensors communicatively coupled to the one or more computing devices. The system includes a remote server communicatively coupled to the one or more computing devices over one or more computer networks. The remote server executes one or more cognitive computing processes. The system includes a sensor module that samples, on a continuous basis at periodic intervals, motion data from one or more sensors of a vehicle while the vehicle is in motion. The system includes an incident module that detects that the vehicle is involved in a traffic incident based on the one or more sensors. The system includes an aggregation module that scrapes, at the time of the traffic incident, external data sources available over one or more data networks for data related to the traffic incident, and supplements the sampled motion data with the scraped data related. The system includes a recommendation module that generates and makes available, in real-time, one or more recommendations for responding to the traffic incident using cognitive computing processes based on the supplemented motion data. The one or more recommendations include information specific to a role of one or more individuals at the traffic incident.

In one embodiment, the remote server that is executing the one or more cognitive computing processes is communicatively coupled to the one or more external data sources to supplement the motion data received at the remote server. In further embodiments, the cognitive computing processes perform one or more machine learning and artificial intelligence functions on the supplemented motion data to determine the one or more recommendations.

In one embodiment, the sensor module samples sensor data from one or more sensors that are external to the vehicle, the one or more sensors associated with vehicles within a proximity of the traffic incident, traffic signal control systems, and/or location services. In further embodiments, the system includes a lockdown module that prevents access to one or more vehicle settings during the traffic incident and formats the sampled motion data in a read-only format.

One embodiment of a method for cognitive-based vehicular incident assistance includes sampling, on a continuous basis at periodic intervals, motion data from one or more sensors of a vehicle while the vehicle is in motion. The method includes detecting that the vehicle is involved in a traffic incident based on the one or more sensors of the vehicle. The method includes scraping, at the time of the traffic incident, external data sources available over one or more data networks for data related to the traffic incident. The method includes supplementing the sampled motion data with the scraped data related to the traffic incident. The method includes generating and making available, in real-time, one or more recommendations for responding to the traffic incident using cognitive computing processes based on the supplemented motion data. The one or more recommendations include information specific to a role of one or more individuals at the traffic incident.

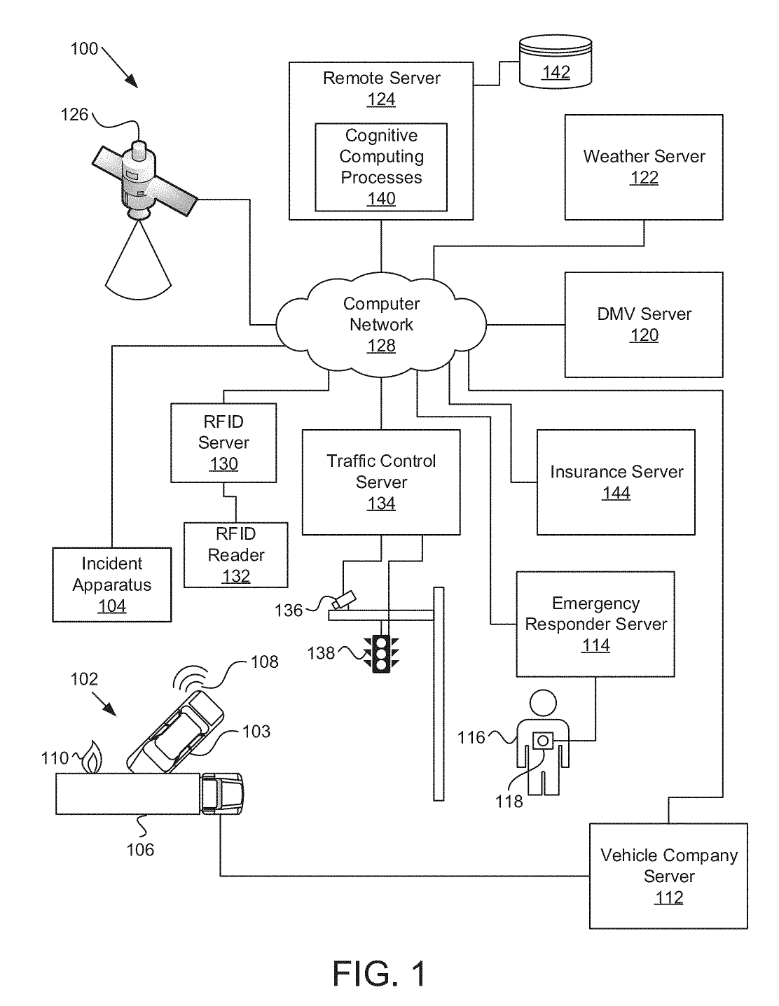

FIG. 1 depicts one embodiment of a system 100 for cognitive-based vehicular incident assistance. In one embodiment, the system 100 illustrates a traffic incident 102. The traffic incident 102 may involve one or more vehicles 103, semi-trucks 106, motorcycles, trucks, sport utility vehicles, cars, trains, bicycles, and/or other forms of transportation. The traffic incident 102 may include a collision that includes a single vehicle 103 (e.g., a collision with a tree, pole, pedestrian, or the like), or a collision that includes multiple different vehicles 103.

In certain embodiments, the vehicles 103 may include various sensors 108 that capture vehicle-specific data. For instance, the vehicles 103 may include speedometers, accelerometers, location sensors (e.g., global positioning system (“GPS”) sensors), cameras, video cameras, microphones, diagnostic sensors (e.g., an on-board diagnostic system), and/or the like, that capture data related to the motion and operation of the vehicles 103. In certain embodiments, the vehicles 103 include various sensors for sampling environment data around the vehicle 103, within a vicinity of the vehicle 103, and/or the like. For example, the vehicles 103 may include motion sensors, proximity sensors, light sensors, sound sensors, cameras, video cameras, temperature sensors, and/or the like. In some embodiments, the vehicles 103, the vehicle's sensors 108, and/or one or more devices within the vehicle 103 may be communicatively coupled to one or more data or computer networks 128 such as Wi-Fi networks, cellular networks, Bluetooth® networks, and/or the like.

In one embodiments, other sensors may be present at the traffic incident 102. For example, if the traffic incident 102 is near a traffic signal 138, the traffic signal system may include cameras 136 that capture images and video of the area around the traffic signal. In another example, responders 116 to the traffic incident 102 such as law enforcement officers, emergency responders, and/or the like may have body cameras 118, or other sensors (e.g., oxygen sensors, smoke sensors, or the like) on their person. Other sensors may include radio frequency tag readers for reading and interpreting RFID tags, wireless signal sensors for capturing wireless signals emitted from wireless devices such as medical transponders.

The incident apparatus 104, in one embodiment, is configured to sample, on a continuous basis at periodic intervals, motion data from sensors 108 of a vehicle 103 while the vehicle 103 is in motion. In certain embodiments, the incident apparatus 104 is configured to detect that a vehicle 103 is involved in a traffic incident 102 based on the vehicle's sensors 108. In response to determining that the vehicle 103 is involved in a traffic incident 102, the incident apparatus 104 scrapes, at the time of the traffic incident 102, external data sources that are available over one or more data networks for data related to the traffic incident 102, and supplements or enhances the sampled motion data with the scraped data. The incident apparatus 104, in further embodiments, generates and makes available, in real-time, one or more recommendations for responding to the traffic incident 102 using cognitive computing processes based on the supplemented motion data. The one or more recommendations may include information specific to a role of one or more individuals at the traffic incident 102.

In certain embodiments, the incident apparatus 104 improves traffic incident assistance and assessment procedures and strategies by providing, real-time, up-to-date, and dynamic information to drivers, law enforcement officers, first responders, and/or the like at a traffic incident 102 using data obtained from vehicle sensors 108 and/or other sensors within a proximity of the traffic incident 102. The captured information is analyzed using cognitive computing processes 140 that perform various machine learning and artificial intelligence algorithms on the data to determine recommendations particular to specific individuals at the traffic incident 102 such as driver-specific recommendations, officer-specific recommendations, responder-specific recommendations, and/or the like. In this manner, the parties involved in the traffic incident 102 may obtain real-time recommendations for responding to the traffic incident 102 such as determining who is at fault for an accident, determining what percentage a driver is at fault for an accident, whether an individual in the vehicle 103, e.g., a driver or a passenger, is injured and needs emergency care, whether the driver violated any traffic laws, and if so, which traffic laws were violated, and/or the like.

In various embodiments, the incident apparatus 104 may be embodied as a hardware appliance that can be installed or deployed on a device such as a computer, phone, or tablet device, or elsewhere on the computer network 128. In certain embodiments, the incident apparatus 104 may include a hardware device such as a secure hardware dongle or other hardware appliance device (e.g., a set-top box, a network appliance, or the like) that attaches to a device such as a laptop computer, a server, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the incident apparatus 104 may include a power interface, a wired and/or wireless network interface, a graphical interface that attaches to a display, and/or a semiconductor integrated circuit device as described below, configured to perform the functions described herein with regard to the incident apparatus 104.

The incident apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the incident apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the incident apparatus 104.

The semiconductor integrated circuit device or other hardware appliance of the incident apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the incident apparatus 104 includes and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The semiconductor integrated circuit device or other hardware appliance of the incident apparatus 104, in some embodiments, is embodied as a portable device that responders 116 can take to a scene of a traffic incident 102 and collect, sense, sample, capture, and process data from the traffic incident 102 and provide real-time and dynamic recommendations and alerts to responders 116 and other individuals at the traffic incident 102 or individuals on the way to the traffic incident 102. In such an embodiment, the portable device may be dedicated, hard-wired, specially programmed, and/or the like to receive sensor data from a vehicle 103 or other sensor location, and generate recommendations based on the collected sensor data using cognitive computing processes 140, either locally on the device or in the cloud.

In some embodiments, the incident apparatus 104 is communicatively coupled to an insurance server 144. The insurance server 144 may be associated with an auto insurance company such as Farmers®, State Farm®, Allstate®, and/or the like. The incident apparatus 104 may send fault information, accident information, and/or the like to the insurance server 144 based on the motion data and/or sensor data that the cognitive computing processes analyze, and/or receive information from the insurance server 144 that is associated with a driver in the traffic incident 102. In this manner, insurance companies can receive accurate, up-to-date fault and accident information for a traffic incident 102.

In one embodiment, the incident apparatus 104 may be communicatively or operably coupled to an RFID server 130 that stores and processes data that the RFID reader 132 captures. The incident apparatus 104 may be communicatively coupled to the RFID server 130 over the computer network 128 to request, access, store, and/or the like RFID data associated with the traffic incident 102.

In another embodiment, the incident apparatus 104 is communicatively coupled to a traffic control server 134 to access data captured by traffic cameras 136 and/or to access data associated with traffic signals 138 (e.g., the state/color of the traffic signal at a certain time). The traffic control server 134 may be a server maintained by a department of transportation or other entity (e.g., the national highway traffic safety administration) that maintains and manages traffic signals 138, traffic data, and/or other traffic control mechanisms.

In further embodiments, the incident apparatus 104 is communicatively coupled to an emergency responder server 114 to access data captured by one or more sensors associated with an emergency responder 116 such as body cameras 118. In some embodiments, the emergency responder server 114 stores data manually entered by emergency responders 116 such as observations, witness statements, and/or the like. The emergency responder server 114 may be maintained by an emergency medical technician (“EMT”) service, a law enforcement service, a firefighter service, and/or the like.

In various embodiments, the incident apparatus 104 is communicatively coupled to a vehicle company server 112 to access information associated with vehicles that are involved in the traffic incident 102. For instance, if a semi-truck that is carrying goods is involved in the traffic incident 102, the incident apparatus 104 may query the vehicle company server 112 for information related to what the goods are that the semi is carrying such as the chemical composition of the goods, the flammability of the goods, the weight of the goods, and/or the like. Other data that the incident apparatus 104 may access from the vehicle company server 112 includes electronic manifests, driver information, source and destination information, and/or the like.

In one embodiment, the incident apparatus 104 is communicatively coupled to a division of motor vehicle (“DMV”) server 120 to access information associated with drivers and/or vehicles 103 that are involved in the traffic incident 102. The information may include identification information, background information (e.g., arrest records, previous citations, and/or the like), and/or the like. The DMV server 120 may be maintained by a government agency and/or other entity that manages and maintains records for drivers and vehicles 103.

In certain embodiments, the incident apparatus 104 is communicatively coupled to a weather server 122 to access current weather information and/or future weather forecasts. The weather information may include temperature information, precipitation information, humidity information, wind information, and/or the like. The weather server 122 may be maintained by a weather agency, a weather station, and/or the like.

The incident apparatus 104, in various embodiments, in communicatively coupled to a location services device 126 such as a satellite service, a GPS service, and/or the like. The location information that the location services device 126 provides may include an address, a point of interest, a GPS coordinate, and/or the like of the traffic incident 102, of responders on the way to the traffic incident 102, and/or the like.

The incident apparatus 104, in one embodiment, is communicatively coupled to a remote server 124 that may be used to perform the various cognitive computing, machine learning, and/or artificial intelligence processes 140 that are applied to the various data that is received from the different data sources in the distributed network. In some embodiments, as used herein, cognitive computing refers to machine learning, reasoning, natural language processing, speech recognition and vision (object recognition), human-computer interaction, dialog and narrative generation, and/or the like processes that are intended to mimic the functioning of the human brain and help improve upon human decision making. IBM's Watson® is one example of a cognitive computing system.

Thus, in certain embodiments, the incident apparatus 104 may perform one or more cognitive computing processes 140 on the data captured by the various data sources/servers and sensors using the remote server 124 in order to generate one or more recommendations for drivers, passengers, and/or responders on the scene of the traffic incident 102 to provide a more complete, accurate, and effective way to determine what happened to cause the traffic incident 102, who is at fault for the traffic incident 102, what percentage parties are at fault for the traffic incident 102, and/or the like. In such an embodiment, the environment data that the sensors capture at the traffic incident 102 is transmitted to the remote server 124 over one or more computer networks 128. In certain embodiments, the sensor data and/or other external data may be stored temporarily at the vehicle 103, or other local device, until the vehicle has a connection to the Internet.

In one embodiment, the cognitive computing processes 140 include a concept insights service, which is accessible using an application programming interface (“API”), that searches documents or files, scrapes websites and/or other online data sources, queries databases, and/or the like for information that is relevant to a search input such as a keyword, an image, a sound, a video, and/or the like. The search input may be determined based on the data received from the various sensors and data sources depicted in FIG. 1 that are related to the traffic incident 102. For example, the concept insights service may access or scrape information from databases, websites, and/or the like associated with previous traffic incidents 102 at the location of the current traffic incident 102 to determine previous conditions under which the previous traffic incidents 102 occurred, e.g., if there are a lot of speed-related incidents at this location, if there are an unusually high number of collisions at this location that are consistently caused by a driver heading in a certain direction, and/or the like.

Once the relevant information is received, a retrieve and rank service takes the relevant information that the concept insights service gathered and ranks the relevant information in order of relevancy to the situation at the traffic incident 102. For instance, it may be relevant to use information from previous collisions if the traffic incident 102 involves two or more vehicles 103, or it may be relevant to make law enforcement officers aware of whether the location of the traffic incident 102 is a high-crime/violent area. The highest-ranked information may be used to generate the recommendations for the individuals present at the traffic incident 102.

The cognitive computing processes 140 may also include an alchemy vision service that analyzes images and/or videos for objects, people, text, and/or the like using image processing. Furthermore, a visual recognition service may be used to allow users to automatically identify subjects and objects contained within images, videos, and/or the like. The output from both the alchemy vision and the visual recognition services may be provided to other services to further process the information such as facial recognition or other image processing services, optical character recognition services, the concept insights service, and/or the like.

In some embodiment, the cognitive computing processes 140 store data from previous processing of traffic incidents 102 in an insights database 142, e.g., a relational database that can be referenced for processing future traffic incidents 102, and which may be embodied as private cloud object storage. In other words, the cognitive computing processes 140 learn from past experiences to provide more accurate results for future traffic incidents 102. For example, the cognitive computing processes 140 may store information that was previously captured/determined during previous traffic incidents 102 including vehicle speeds, vehicle locations, posted speed limits for the location, the date/time of the previous traffic incidents 102, results of the traffic incidents 102 (e.g., assigned fault, citations issued, injuries or deaths caused by the traffic incident 102, and/or the like), weather conditions, and/or the like. The cognitive computing processes 140 may then use data from the current traffic incident 102, as captured by the vehicle sensors 108 and/or other sensors at the scene of the traffic incident, to query or scrape the database 142 for conditions or situations that are similar to the current traffic incident 102 based on the sampled sensor data. The concept insights service, for example, may reference the previously captured data, and use it to generate recommendations for responding to a current traffic incident 102 if a similar condition or situation is present at the current traffic incident 102, in addition to the other data obtained from other external data sources.

In some embodiments, at least a portion of the cognitive computing processes 140 are performed locally on a device that is present at the scene of the traffic incident 102, on a computer within a vehicle 103 involved in the traffic incident 102, and/or the like. In certain embodiments, for example, the incident apparatus 104 may not have access to the computer network 128, and thus the cognitive computing processes 140 located in the cloud may not be available to the incident apparatus 104. Accordingly, the incident apparatus 104 may perform at least a portion of the cognitive computing processes 140 on a device that is located at the traffic incident 102 to provide recommendations that are as accurate as possible based on the sensor data that is captured at the scene of the traffic incident 102.

The computer network 128, in one embodiment, includes a digital communication network that transmits digital communications. The computer network 128 may include a wireless network, such as a wireless cellular network, a local wireless network, such as a Wi-Fi network, a Bluetooth® network, a near-field communication (“NFC”) network, an ad hoc network, and/or the like. The computer network 128 may include a wide area network (“WAN”), a storage area network (“SAN”), a local area network (“LAN”), an optical fiber network, the internet, or other digital communication network. The computer network 128 may include two or more networks. The computer network 128 may include one or more servers, routers, switches, and/or other networking equipment. The computer network 128 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT-F® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA” ®). Alternatively, the wireless connection may be a cellular telephone network communication. All standards and/or connection types include the latest version and revision of the standard and/or connection type as of the filing date of this application.

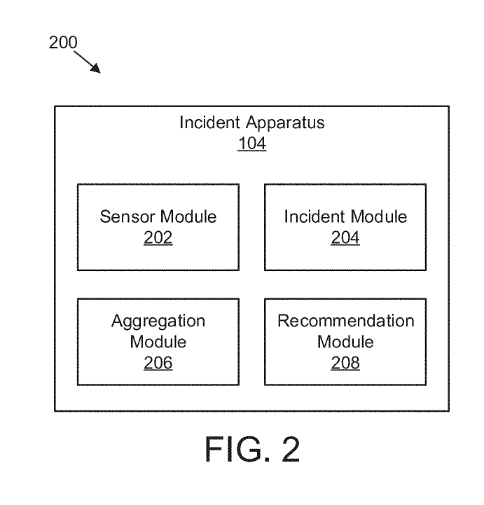

FIG. 2 depicts one embodiment of an apparatus 200 for cognitive-based vehicular incident assistance. The apparatus 200 includes an instance of an incident apparatus 104. The incident apparatus 104 includes one or more of a sensor module 202, an incident module 204, an aggregation module 206, and a recommendation module 208, which are described in more detail below.

The sensor module 202, in one embodiment, is configured to sample motion data from one or more sensors 108 of a vehicle 103 while the vehicle 103 is in motion. For example, the sensor module 202 may sample data from a speedometer, an accelerometer, braking sensors, and/or the like to sample how fast the vehicle 103 is motion at various periods of time, to determine when the vehicle 103 speeds-up or slows-down, to determine how long a vehicle 103 has traveled at a particular speed, to determine an average speed of the vehicle 103, and/or the like. In certain embodiments, the sensor module 202 may use GPS data to determine the vehicle's 103 speed over a period of time using a beginning point and an ending point, and the time it takes for the vehicle 103 to get from the beginning point to the ending point.

The sensor module 202 may collect other data from the vehicle's sensors 108 while the vehicle 103 is in motion such as vehicle diagnostic data, weather/temperature data, camera data (e.g., images and/or video), audio data, location data, airbag deployment data, and/or the like. For example, the sensor module 202 may store or buffer video data captured with a backup camera, a dashboard camera, and/or the like at periodic intervals while the vehicle 103 is moving.

In various embodiments, the sensor module 202 samples motion data on a continuous basis at periodic intervals. For instance, the sensor module 202 may begin collecting motion data when the vehicle 103 is started, or starts moving, and may continue to collect motion data every thirty seconds, every minute, every five minutes, and/or the like. In this manner, many sets of motion data may be captured at periodic intervals that together may form a picture of the motion of the vehicle 103 over time.

In certain embodiments, the data storage on the vehicle 103, e.g., volatile storage and/or non-volatile storage, may not be sufficient to store many sets of motion data. Accordingly, the sensor module 202 may store motion data in a first-in-last-out method such that when a new set of motion data is stored, the oldest set of motion data is removed or deleted from storage. In some embodiments, the sensor module 202 receives input from a user to configure how often the sensor module 202 samples motion data, how many sets of motion data to store at one time, which motion data to sample, and/or the like.

In one embodiment, the incident module 204 detects that a vehicle 103 is involved in a traffic incident 102 based on data from the one or more sensors 108 of the vehicle 103. The traffic incident 102 may include a collision or other accident that involves the vehicle 103, being pulled-over by a police officer, and/or the like. For instance, the incident module 204 may detect that a user is getting pulled over by a law enforcement office by detecting that the vehicle's speed is reducing by detecting police lights using video and/or camera data and/or by detecting police sirens using a microphone or other sound sensor on the vehicle 103. In another example, the incident module 204 may detect that a vehicle 103 is involved in an accident by detecting data from various impact sensors, airbag deployment sensors, and/or the like.

In one embodiment, the sensor module 202 immediately captures a set of motion data for the vehicle 103 in response to the incident module 204 detecting that the vehicle 103 is involved in a traffic incident 102. For example, if the incident module 204 detects that a user is being pulled over based on detecting the lights and sirens of a police car, the sensor module 202 may sample motion data for the vehicle 103, using the vehicle's sensors 108 (e.g., video camera and audio data), which may be useful in determining whether the officer has reasonable grounds for pulling the user over.

In another example, if the incident module 204 detects that the user is involved in an accident, based on the vehicle's impact sensors, for example, the sensor module 202 may capture motion data from the vehicle's sensors 108 at the point of impact, or at a period of time just before the point of impact. For instance, the sensor module 202 may buffer the sensor data in buffers associated with each sensor to keep a rolling sample of motion data for some short period of time (e.g., seconds, microseconds, or the like), and when the incident module 204 detects that the vehicle 103 is involved in an accident, the sensor module 202 may commit the motion data that is captured in the sensor buffers at the time of the impact, or at a time just prior to the time of impact, to non-volatile storage.

In one embodiment, the aggregation module 206 is configured to scrape, at the time of the traffic incident 102, e.g., in response to the incident module 204 detecting that the vehicle 103 is involved in a traffic incident 102, one or more external data sources available over one or more computer networks 128 for data related to the traffic incident 102. For example, in one embodiment, the sensor module 202 samples or captures sensor data from one or more sensors that are external to the vehicle 103 in response to the incident module 204 detecting that the vehicle 103 is involved in a traffic incident 102. For instance, the sensor module 202 may capture data from traffic cameras 136, e.g., from a traffic control server 134, from one or more sensors of proximate vehicles 103 (e.g., video camera data from a car that is stopped at the intersection where a car accident occurred), from body cameras 118 worn by officers and other responders 116, from weather sensors, location sensors, and/or the like. In such an embodiment, the aggregation module 206 supplements or enhances the sampled motion data with the data from the external sensors.

In another embodiment, the aggregation module 206 scrapes data from various external data sources such as websites (e.g., using a web crawler), government or public safety databases, and/or the like for data that may be associated with the traffic incident 102 (e.g., posted speed limit information, intersection or road configuration information, or the like for the particular location from a department of transportation website or database; traffic incident 102 information from previous traffic incidents 102 in this particular area and/or with similar characteristics; and/or the like).

In one embodiment, the recommendation module 208 generates and makes available, in real-time, one or more recommendations for responding to the traffic incident 102 using the cognitive computing processes 140. For instance, the recommendation module 208 may transmit the supplemented motion data to the remote server 124 to be processed, analyzed, and/or the like by the cognitive computing processes 140 to determine one or more recommendations for responding to the traffic incident 102.

In particular, in one embodiment, the cognitive computing processes 140 may analyze the sampled motion data, the external sensor data, data from previous traffic incidents 102, scraped data from external data sources, and/or the like and performs various machine learning and/or artificial intelligence processes on the data. For instance, the cognitive computing processes 140 may perform various image processing algorithms on video camera data from traffic cameras, dashboard cameras, backup cameras, and/or the like at a traffic accident, in addition to speed data captured by the vehicle's speed sensors, to determine who was at fault in the traffic accident.

For example, the cognitive computing processes 140 may search the insights database 142 for accident data related to a car accident at an intersection that has a two-way stop. The database 142 may include a set of data for accidents that occurred at the intersection where 80% of the accidents were caused by a user who failed to stop at one of the stop signs at the intersection. The cognitive computing processes 140 may use this data together with the motion data, e.g., speed data, braking data, and/or the like to determine if a driver failed to stop at a stop sign), and external sensor data, e.g., traffic cameras, weather data, and/or the like, to determine which driver was at fault in the car accident. Based on the results, the cognitive computing processes 140 may generate recommendations for the driver, for law enforcement officers, for first responders, or the like that provide conclusions, details, tips, advice, and/or the like for responding to the accident. For instance, the recommendations for a law enforcement officer may specify who was at fault for the car accident, e.g., the driver that failed to stop at the stop sign, what percentage the driver was at fault, e.g., 100%, and citations that may be given to the driver at fault.

Continuing with the previous example, the cognitive computing processes 140 may further determine, based on an analysis of the previously stored traffic incident 102 data in the insights database 142, that the driver of the vehicle 103 that fails to stop at the intersection suffers a head trauma injury 60% of the time. Accordingly, the cognitive computing processes 140 may generate recommendations for emergency responders, e.g., emergency medical technicians, who arrive at the traffic incident 102 for treating traumatic head injuries.

Furthermore, continuing with the previous example, the cognitive computing processes 140 may generate recommendations for the drivers of the vehicles 103 that include fault information, e.g., the relative fault of each driver in the accident, who to contact in the area about the accident and the contact information, e.g., contact information for police, emergency responders, insurance companies, towing companies, and/or the like, what to say to an officer or first responder, e.g., how to explain injuries, how to stay calm and interact with an officer who may be incorrect, and/or the like. Thus, the cognitive computing processes 140 generate recommendations for various individuals that may be involved in the traffic incident 102.

The recommendation module 208 may provide the recommendations that the cognitive computing processes 140 generate to individuals in real-time according to the role of the individual, e.g., driver, passenger, law enforcement officer, emergency responder, and/or the like. The recommendation module 208 may make the recommendations available in real-time by storing the recommendations on the storage system of the vehicle 103 in the traffic incident 102, if available, or on the remote server 124 or other cloud device that the individuals have access to. The recommendation module 208 may push the recommendations to individuals' devices, e.g., as a push notification, in response to the individuals being within a proximity of the traffic incident 102, e.g., over Bluetooth®, NFC, or some other wireless network connection. The recommendation module 208 may send a text message, email message, instant message, social media message, and/or any other type of electronic message that contains the recommendations. In certain embodiments, a dispatch system receives the recommendations and sends the recommendations to law enforcement officers and first responders at the scene.

In certain embodiments, the cognitive computing processes 140 determine a risk level of each of the recommendations. In some embodiments, the cognitive computing processes 140 may evaluate the pros and cons of each recommendation, by intelligently forecasting or predicting possible outcomes or consequences of each recommendation, and assigning a risk value to each recommendation based on the predicted outcome. For instance, the cognitive computing processes 140 may generate five options or actions for a driver to take if he is pulled over such as notify the insurance agency, text family and/or friends, begin video tapping the interaction with the officer, start taking out driving license/registration/proof of insurance, cooperate with the officer, keep hands on the steering wheel, inform the officer if you are carrying a concealed carry permit, and so on. The cognitive computing processes 140 may analyze each possible recommendation by comparing it to previous outcomes from actions taken in previous traffic incidents 102 that are similar to the instant traffic incident 102, as provided by the data in the insights database 142 and/or other external data sources.

Thus, the cognitive computing processes 140 may anticipate, forecast, and/or predict the outcomes/consequences of certain actions and assign a weight or risk value to each recommendation based on the predicted outcome. For example, videotaping an officer during a traffic stop may have a higher risk than cooperating with the officer, based on data from previous traffic incidents 102, news stories, and/or the like. Accordingly, the risk value associated with videotaping the officer will be higher than the risk value associated with cooperating with the officer. The recommendation module 208, in one embodiment, displays the risk value with the presented recommendations so that the user can make an educated decision about which recommendation to pursue.

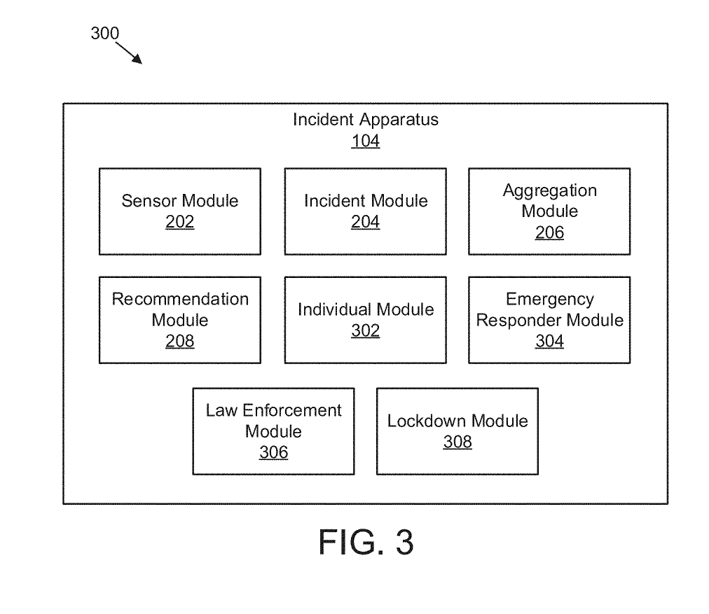

FIG. 3 depicts one embodiment of another apparatus 300 for cognitive-based vehicular incident assistance. The apparatus 300 includes an instance of an incident apparatus 104. The incident apparatus 104 includes one or more of a sensor module 202, an incident module 204, an aggregation module 206, and a recommendation module 208 which may be substantially similar to the sensor module 202, the incident module 204, the aggregation module 206, and the recommendation module 208 described above with reference to FIG. 2. The incident apparatus 104 also includes an individual module 302, an emergency responder module 304, a law enforcement module 306, and a lockdown module 308, which are described in more detail below.

The individual module 302, in one embodiment, is configured to determine whether an individual in the vehicle 103 (e.g., the driver or passenger) is conscious and/or injured. In one embodiment, the individual module 302 provides an audio prompt through the vehicle's 103 sound system to determine whether the driver or another passenger is conscious. For instance, the individual module 302 may provide an audio prompt in response to the incident module 204 determining that the vehicle 103 is involved in a traffic accident.

The audio prompt may include questions for determining whether the user is conscious, the user's level of consciousness, whether the user is injured, and/or to what degree the user is injured. For instance, the individual module 302 may prompt the driver for the driver's name. If the user correctly provides his name, and/or answers to any follow-up prompts that the individual module 302 provides, then the individual module 302 may determine that the individual is conscious. The recommendation module 208 may then generate one or more recommendations for the individual, e.g., the driver or passenger. The one or more recommendations, as described above, may include information for the individual such as recommendations for treating injuries, if any (as determined through the series of audio prompts), recommendations for interacting with law enforcement officers, emergency responders, and/or the like.

Otherwise, if no sound is detected in response to the audio prompt, or if the sound is inaudible, muffled, slurred, or the answer to the prompt is incorrect, then the individual module 302 may determine that the driver is unconscious, confused, dizzy, or otherwise badly injured. In such an embodiment, the recommendation module 208 provides notifications to law enforcement and/or emergency responders to let them know that the driver and/or other passengers are unconscious and/or injured at the scene. Furthermore, as part of the recommendations, the cognitive computing processes 140 may analyze the traffic accident, based on the motion data and/or other external data, and estimate, forecast, or predict the types of injuries that the individuals in the vehicles 103 are likely to have sustained.

In one embodiment, the emergency responder module 304 is configured to generate one or more recommendations that include emergency response information for emergency responders. The emergency response information may include the number of individuals involved in the traffic incident 102 (e.g., as determined based on sensors in the vehicle's seats), the possible types of injuries that may have been sustained for the particular type of accident, as described above, treatment options/suggestions for the predicted and known injuries, the types of equipment that may be useful at the accident, the identities of the individuals involved in the accident and any medical conditions that the individuals may have, and/or the like.

In one embodiment, the law enforcement module 306 is configured to generate the one or more recommendations with law enforcement information related to the traffic incident 102 and presented to one or more law enforcement officers on the scene at the traffic incident 102. In certain embodiments, the law enforcement information includes fault information that describes which parties are at fault, what percentage the parties are at fault, and/or the like; information for issuing citations and suggested citations to issue to the individuals involved; the names and background information for the individuals involved in the traffic incident 102; and/or the like.

For example, the law enforcement module 306 may generate recommendations for issuing a speeding ticket to a driver who the law enforcement officer pulled over for speeding. In such an embodiment, the cognitive computing processes 140 may analyze the motion data, e.g., the speed data, the posted speed limits at the location where the driver was pulled over, the weather conditions, video and/or camera data, and/or the like to determine with near 100% certainty whether the driver was speeding or not. The results may be provided to both the law enforcement officer and the driver so that the law enforcement officer and the driver have evidence related to the driver's traffic violation, and whether it suggests that the driver is guilty or not. In this manner, the guilt or innocence of a party can be determined at the scene of the traffic incident 102, which may discourage individuals from challenging traffic violations and/or from officers issuing incorrect violations.

The lockdown module 308, in one embodiment, is configured to prevent access to one or more vehicle settings during the traffic incident 102 and/or formats the sampled motion data in a read-only format. For instance, if the incident module 204 detects that a vehicle 103 is involved in a traffic incident 102, the lockdown module 308 securely prevents access to sensor configurations, account management, super user access, cognitive permutation levels; prevents motion and other captured sensor data from being overwritten or deleted; prevents access by mobile devices and application software that are synced with the vehicle 103; and/or the like so that the driver or another individual cannot tamper with or otherwise corrupt the data.

To access the data, the lockdown module 308 may require credentials such as a password, a passphrase, biometric data, and/or the like so that drivers, law enforcement officers, emergency responders, and/or the like can access the raw motion and sensor data, the generated recommendations, and/or the like. Furthermore, the lockdown module 308 may securely transmit recommendations, data, and/or the like to the drivers, passengers, law enforcement officers, and/or emergency responders using secure communication encryption such as transport layer security (“TLS”) or its predecessor known as secure sockets layer (“SSL”).

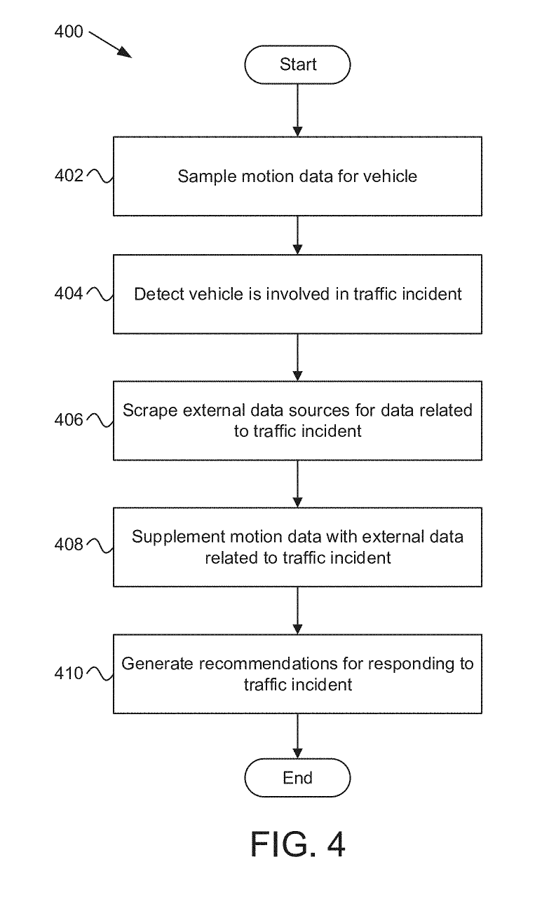

FIG. 4 depicts one embodiment of a method 400 for cognitive-based vehicular incident assistance. In one embodiment, the method 400 begins and samples 402, on a continuous basis at periodic intervals, motion data from one or more sensors 108 of a vehicle 103 while the vehicle 103 is in motion. In further embodiments, the method 400 detects 404 that the vehicle 103 is involved in a traffic incident 102, e.g., a traffic accident, is pulled over, or other traffic-related incident, based on the one or more sensors 108 of the vehicle 103.

In certain embodiments, the method 400 scrapes 406, at the time of the traffic incident 102, external data sources available over one or more data networks for data related to the traffic incident 102, and supplements 408 the sampled motion data with the scraped data related to the traffic incident 102. The method 400, in various embodiments, generates 410 and makes available, in real-time, one or more recommendations for responding to the traffic incident 102 using cognitive computing processes 140 based on the supplemented motion data. The one or more recommendations may include information specific to a role of one or more individuals at the traffic incident 102, and the method 400 ends. In certain embodiments, the sensor module 202, the incident module 204, the aggregation module 206, and the recommendation module 208 perform the various steps of the method 400.

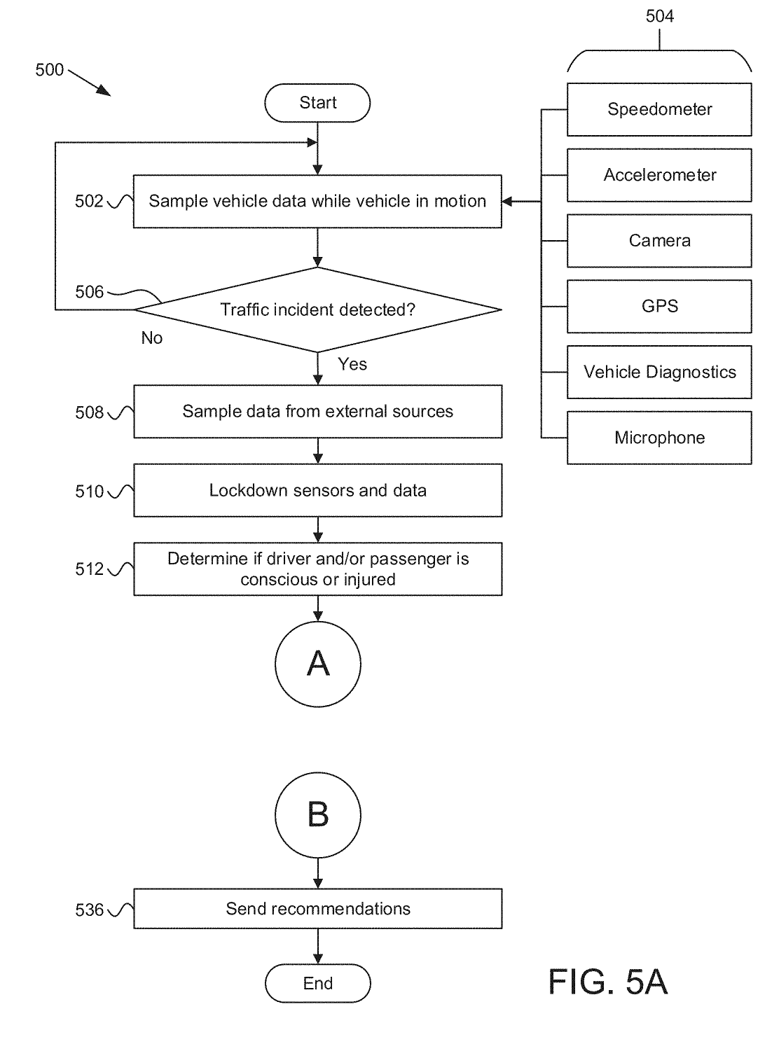

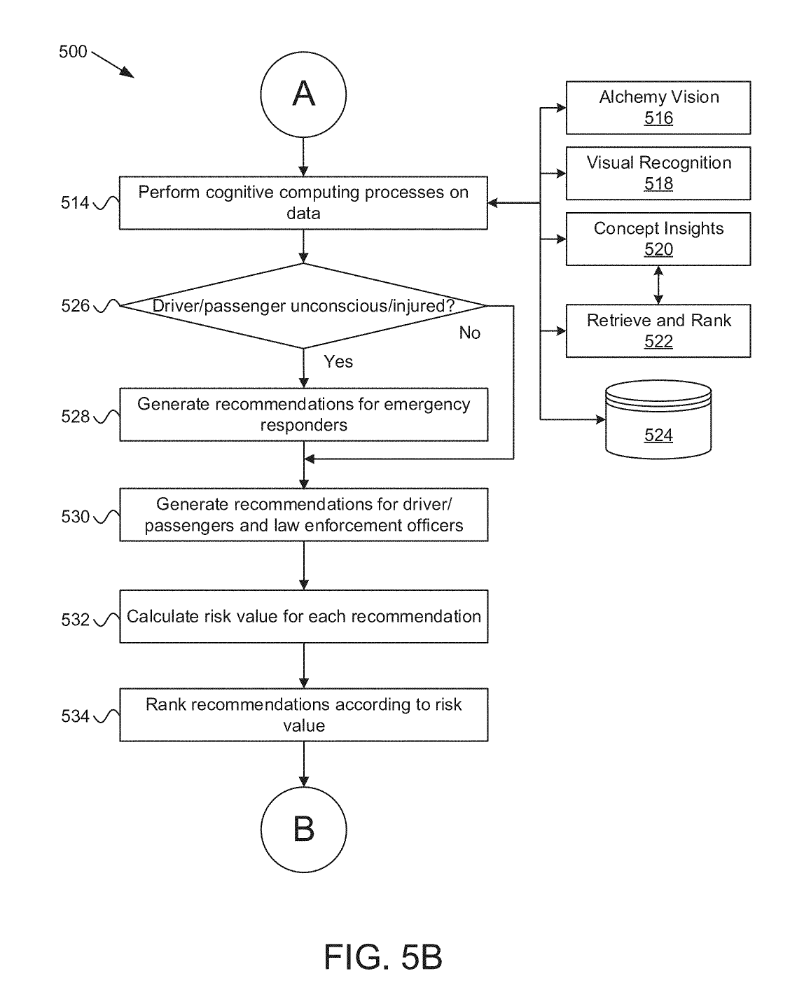

FIGS. 5A and 5B depict one embodiment of a method 500 for cognitive-based vehicular incident assistance. In one embodiment, the method 500 begins and samples 502, on a continuous basis at periodic intervals, motion data from one or more sensors 108 of a vehicle 103 while the vehicle 103 is in motion. The motion data may be captured from various sensors 504 within the vehicle 103 such as a speedometer, an accelerometer, a camera, a GPS, a vehicle diagnostic, a microphone, and/or the like.

In some embodiments, the method 500 determines 506 whether a traffic incident 102 has occurred. If not, the method 500 continues to sample 502 motion data for the vehicle 103 while the vehicle 103 is in motion. Otherwise, the method 500 samples 508 data from one or more external sources such as sensors from other vehicles 103 involved in, or within the vicinity of, the traffic incident 102, traffic cameras 136, body cameras 118, and/or the like.

In further embodiments, the method 500 locks-down 510 the sensors 108 and the motion data stored on the vehicle 103 to prevent the sensor configurations and data from being tampered with. In such an embodiment, the method 500 may format the data in a read-only format so that the data cannot be altered, modified, or overwritten.

In certain embodiments, the method 500 determines 512 whether one or more individuals within the vehicle 103 are conscious and/or injured. The method 500, in some embodiments, performs 514 cognitive computing processes 140 on the motion data, sensor data, data from external sources, and/or data from an insights database 142/524, using one or more cognitive processing services such as an alchemy vision service 516, a visual recognition service 518, a concept insights service 520, and a retrieve and rank service 522.

In one embodiment, if the method 500 determined 526 that an individual in the vehicle 103, e.g., the driver or another passenger, involved in the traffic incident 102 is unconscious and/or injured, the method 500 generates 528 one or more recommendations for emergency responders to use when responding to the traffic incident 102. Otherwise, in certain embodiments, the method 500 generates 530 one or more recommendations for individuals and/or law enforcement officers involved in the traffic incident 102.

The method 500, in some embodiments, calculates 532 a risk value for each of the recommendations for each of the individuals in the vehicle 103, law enforcement officers, and/or emergency responders, and ranks 534 the recommendations according to the risk value calculated for each recommendation. The method 500 sends 536 the one or more recommendations to the respective individuals, and the method 500 ends. In one embodiment, the sensor module 202, the incident module 204, the aggregation module 206, the recommendation module 208, the individual module 302, the emergency responder module 304, the law enforcement module 306, and/or the lockdown module 308 perform the various steps of the method 500.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a sensor module that samples, on a continuous basis at periodic intervals, motion data from one or more sensors of a vehicle while the vehicle is in motion;
an incident module that detects that the vehicle is involved in a traffic incident based on the one or more sensors of the vehicle;
an aggregation module that:
scrapes, at the time of the traffic incident, external data sources available over one or more data networks for data related to the traffic incident; and
supplements the sampled motion data with the scraped data related to the traffic incident; and
a recommendation module that generates and makes available, in real-time, one or more recommendations for responding to the traffic incident using cognitive computing processes based on the supplemented motion data, the one or more recommendations comprising information specific to a role of one or more individuals at the traffic incident.

2. The apparatus of claim 1, wherein the cognitive computing processes are performed on a remote server accessible via the Internet from one or more devices at the traffic incident, the remote server communicatively coupled to the one or more external data sources to supplement the motion data received at the remote server.

3. The apparatus of claim 1, wherein the cognitive computing processes perform one or more machine learning and artificial intelligence functions on the supplemented motion data to determine the one or more recommendations.

4. The apparatus of claim 1, wherein the cognitive computing processes calculate a risk value associated with each of the one or more recommendations based on the supplemented motion data, the risk value presented with the one or more recommendations.

5. The apparatus of claim 1, wherein the cognitive computing processes further access and analyze traffic incident data from previous traffic incidents for traffic incident data that is similar to one or more conditions of the traffic incident to generate the one or more recommendations for responding to the traffic incident.

6. The apparatus of claim 1, further comprising an individual module that determines whether an individual in the vehicle is conscious and injured, the one or more recommendations generated with information for the individual and presented to the individual in response to determining that the individual is conscious, the individual information comprising one or more of recommendations for treating an injury, recommendations for cooperating with law enforcement officers, and recommendations for interacting with emergency responders.

7. The apparatus of claim 6, wherein the individual module presents one or more audible prompts through the vehicle to the individual to determine whether the individual is conscious and injured based on the individual's responses to the audible prompts.

8. The apparatus of claim 1, further comprising an emergency responder module that generates the one or more recommendations with emergency response information related to the traffic incident and presented to one or more emergency responders on scene at the traffic incident in response to determining that an individual in the vehicle is one of unconscious and injured, the emergency response information comprising treatment recommendations for the individual.

9. The apparatus of claim 1, further comprising a law enforcement module that generates the one or more recommendations with law enforcement information related to the traffic incident and presented to one or more law enforcement officers on scene at the traffic incident, the law enforcement information comprising one or more of fault information and citation recommendations.

10. The apparatus of claim 1, wherein the sensor module samples sensor data from one or more sensors that are external to the vehicle, the one or more sensors associated with one or more of vehicles within a proximity of the traffic incident, traffic signal control systems, and location services.

11. The apparatus of claim 1, wherein the sensor module stores motion data in a first-in-last-out manner such that when a new set of motion data is sampled, the oldest set of sampled motion data is removed from storage.

12. The apparatus of claim 1, wherein the sensor module immediately samples a set of motion data in response to the incident module detecting that the vehicle is involved in a traffic incident.

13. The apparatus of claim 1, further comprising a lockdown module that prevents access to one or more vehicle settings during the traffic incident and formats the sampled motion data in a read-only format.

14. The apparatus of claim 1, wherein the one or more sensors of the vehicle are selected from the group consisting of a speedometer, an accelerometer, a camera, a video camera, a sound sensor, a proximity sensor, a motion sensor, and a location sensor.

15. A system comprising:
a vehicle comprising one or more computing devices;
one or more sensors communicatively coupled to the one or more computing devices;
a remote server communicatively coupled to the one or more computing devices over one or more computer networks, the remote server executing one or more cognitive computing processes;
a sensor module that samples, on a continuous basis at periodic intervals, motion data from the one or more sensors while the vehicle is in motion;
an incident module that detects that the vehicle is involved in a traffic incident based on the one or more sensors;
an aggregation module that:
scrapes, at the time of the traffic incident, external data sources available over one or more computer networks for data related to the traffic incident; and
supplements the sampled motion data with the scraped data related to the traffic incident; and
a recommendation module that generates and makes available, in real-time, one or more recommendations for responding to the traffic incident using the cognitive computing processes based on the supplemented motion data, the one or more recommendations comprising information specific to a role of one or more individuals at the traffic incident.

16. The system of claim 15, wherein the remote server that is executing the one or more cognitive computing processes is communicatively coupled to the one or more external data sources to supplement the motion data received at the remote server.

17. The system of claim 15, wherein the cognitive computing processes perform one or more machine learning and artificial intelligence functions on the supplemented motion data to determine the one or more recommendations.

18. The system of claim 15, wherein the sensor module samples sensor data from one or more sensors that are external to the vehicle, the one or more sensors associated with one or more of vehicles within a proximity of the traffic incident, traffic signal control systems, and location services.

19. The system of claim 15, further comprising a lockdown module that prevents access to one or more vehicle settings during the traffic incident and formats the sampled motion data in a read-only format.

20. A method comprising:
sampling, on a continuous basis at periodic intervals, motion data from one or more sensors of a vehicle while the vehicle is in motion;
detecting that the vehicle is involved in a traffic incident based on the one or more sensors of the vehicle;
scraping, at the time of the traffic incident, external data sources available over one or more data networks for data related to the traffic incident;
supplementing the sampled motion data with the scraped data related to the traffic incident; and
generating and making available, in real-time, one or more recommendations for responding to the traffic incident using cognitive computing processes based on the supplemented motion data, the one or more recommendations comprising information specific to a role of one or more individuals at the traffic incident.
